(19) United States
(12) Patent Application Publication
(10) Pub. No.: US 2021/0140795 A1
(43) Pub. Date: May 13, 2021

(54) Method and Device for Creating a Calibration Value for Calibrating an Inertial Measurement Unit for a Vehicle

(71) Applicant: Robert Bosch GmbH, Stuttgart (DE)

(72) Inventor: Marcell Jozsa, Szekesfehervar (HU)

(21) Appl. No.: 17/092,994

(22) Filed: Nov. 9, 2020

(30) Foreign Application Priority Data
Nov. 12, 2019 (DE) 102019217448.5

(51) Int. Cl. G01C 25/00; G01C 21/20; G01C 21/16

(52) U.S. Cl. CPC G01C 25/005; G01C 21/16; G01C 21/20

(57) ABSTRACT

A method for producing a calibration value for calibrating an inertial measurement unit for a vehicle includes reading a first measurement value of a physical variable in a first measurement direction of a measuring sensor of an inertial measurement unit and reading a second measurement value of the physical variable in a second measurement direction of the measuring sensor of the inertial measurement unit, which is different from the first measurement direction. The method further includes reading a first reference value of the physical variable in a first reference measurement direction of a reference sensor and a second reference value of the physical variable in a second reference measurement direction of the reference sensor which is different from the first reference measurement direction. The method also includes determining a first correction angle value using the first measurement value and the first reference value.

This application claims priority under 35 U.S.C. § 119 to patent application no. DE 10 2019 217 448.5, filed on Nov. 12, 2019 in Germany, the disclosure of which is incorporated herein by reference in its entirety.

### BACKGROUND

The use of IMU sensors (IMU=inertial measurement unit) for a motion and position sensor, in short “VMPS” (Vehicle Motion and Position Sensor) or MMP2 is indispensable. These sensors enable increased accuracy of inertia measurements for various purposes of automated driving, for example high accuracy of an absolute and relative position determination. However, these IMU sensors are not fully designed for a desired purpose with very high precision requirements, therefore an advanced characterization and/or calibration of an IMU sensor is necessary to achieve a desired result.

Also the offset compensation, especially for compensating an orientation of the measurement axes of the sensors, is a crucial component of the calibration. In most cases, these processes are time-consuming, which is not feasible or will be very problematic for mass production.

### SUMMARY

Against this background, the approach presented here sets out a method, also a device that uses this method, as well as finally a corresponding computer program.

In accordance with the presented approach, a method is presented here for producing a calibration value for calibrating an inertial measurement unit for a vehicle, wherein the method has the following steps:
Reading a first measurement value of a physical variable in a first measurement direction of a measuring sensor of an inertial measurement unit and a second measurement value of the physical variable in a second measurement direction different from the first measurement direction of the measuring sensor of the inertial measurement unit and reading a first reference value of the physical variable in a first reference measurement direction of a reference sensor and a second reference value of the physical variable in a second reference measurement direction of the reference sensor different from the first reference measurement direction;
Determining a first correction angle value using the first measurement value and the first reference value and determining a second correction angle value using the second measurement value and the second reference value; and
Storing the first and second correction angle values in a memory of the inertial measurement unit to obtain the calibration value.

In the present case, a measurement value can be understood as a value that is provided by a sensor of the inertial measurement unit. A reference sensor can be understood in the present case to mean a sensor which is arranged outside the inertial measurement unit, for example in a laboratory environment. A measurement direction or reference measurement direction can be understood as a spatial direction in which the measuring sensor or the reference sensor is sensitive. A correction angle value in the present case can be defined as a value which will be linked to the measurement value during a subsequent operation of the inertial measurement unit while the vehicle is travelling in order to compensate for a directional offset by a simulated rotation of the measurement axes relative to a corresponding reference measurement direction. For this purpose, for example, the correction angle value can have a first component that represents a correction value of the measurement value in the first measurement direction/reference measurement direction and/or a second component which represents a correction value of the measurement value in the second measurement direction/reference measurement direction and or a third component, which represents a correction value of the measurement value in the third measurement direction/reference measurement direction. These correction values can then be, for example, added to the respective measurement value, multiplied by the measurement value, or subtracted from this measurement value, in order to reach a real value corresponding to a “virtual” measurement value in the respective reference measurement direction.

The approach presented here is based on the realization that by determining the first and second correction angle values and the resulting calibration value, there is a possibility of compensating for rotation of the measurement directions of the measuring sensor, which arose during production, for example. In this way, during subsequent operation of the measuring sensors, for example when the vehicle is travelling, correct measurement values can be recorded in such a way that they correspond to measurement values which would be recorded in a corresponding reference measurement direction of the reference sensor. It is therefore possible to improve a conventional low-cost measuring sensor through the approach presented here, so that a complex or calibrated measurement value is output with very high precision.

An embodiment of the approach proposed here is advantageous, with which in the step of determining the first correction angle value it is determined in such a way that it represents an angular offset between the first measurement direction and the first reference measurement direction and the second correction angle value is determined in such a way that it represents an angular offset between the second measurement direction and the second reference measurement direction. Such an embodiment offers the advantage of being able to very easily compensate the angular offset or the misalignment of the measurement axes of the measuring sensor relative to the orientation of the measurement axes of the reference sensor.

Also, according to a further embodiment of the approach proposed here, in the step of determining the first correction angle value it can be determined in such a way that a component has the second reference measurement direction and/or the third reference measurement direction and/or the second correction angle value is determined in such a way that it has a component of the first reference measurement direction and/or the third reference measurement direction. In this way, a more precise calibration value can be determined very flexibly and quickly, which can be used to correct measurement values of the measuring sensor.

According to an additional embodiment of the approach presented here, in the reading step a third measurement value of the physical variable is read in a third measurement direction of the measuring sensor of the inertial measurement unit which is different from the first and second measurement directions, and a third reference value of the physical variable is read in a third measurement direction of the reference sensor, which is different from the first and second measurement directions, wherein in the determining step a third correction angle value is determined using the third measurement value and the third reference value and wherein in the storing step the third correction angle value is stored in the memory of the inertial measurement unit to obtain the calibration value. Such an embodiment offers the advantage to also be able to compensate a measurement value in a third spatial direction, so that a very flexible and universally applicable concept for the correction of measurement values of an inertial measurement unit of the vehicle can now be provided.

The calibration value for the calibration of the inertial measurement unit for the vehicle can be determined particularly rapidly and efficiently by determining the first and second correction angle values in the determining step by means of artificial intelligence algorithm, in particular a neural network. In this case, already known, fast-working algorithms for processing signals may be used.

In order to provide a particularly precise calibration value, the first and/or second reference measurement values from a stationary or moving reference sensor can be read in a laboratory environment in the reading step. In this case in the laboratory environment the stationary sensor can have very high quality with regard to the provision of the reference values as a reference sensor.

Particularly relevant is an embodiment of the method presented here, with which in the reading step a value representing an acceleration as a physical variable for the first measurement value, the second measurement value (or the third measurement value), the first reference measurement value and the second reference measurement value (and possibly also the third reference measurement value) can be read in. Such an embodiment offers the advantage that an acceleration as a measurement value for further processing in a vehicle is of great consequence for autonomous driving, so the approach presented here is very well suited for providing very precise position values.

Particularly advantageous is an embodiment of the approach proposed here, in which in the determining step the first and second correction angle values are jointly determined in an algorithm or working step, wherein the first measurement value, the first reference value, the second measurement value and the second reference value are used to determine the first and second correction angle values. Such an embodiment allows, for example, the joint determination of the first and second correction angle values compared to a separate determination of the first and second correction angle values, i.e. compared to separate evaluation of the measurement values of each individual measuring device. In this way, by taking into account measurement values in at least two different measurement directions/reference directions, a larger amount of information can also be processed, so that the first and second correction angle values are of higher quality.

Furthermore, a method for compensating a measurement value of a measuring sensor of an inertial measurement unit is presented, wherein the method has the following steps:
Reading at least the measurement value from the measuring sensor of the inertial measurement unit and a calibration value stored in a memory unit of the inertial measurement unit according to a variant of a method presented here; and
Determining a compensated measurement value using the measurement value and the calibration value.

Also by such a variant, the advantages of the approach presented here can be realized quickly and easily, especially if the inertial measurement unit is used during the intended operation of the vehicle and the calibration value was stored in the memory beforehand.

Variants of this method may be implemented, for example, in software or hardware or in a mixed form of software and hardware, for example in a control unit or a device.

The approach presented here also produces a device which is designed to carry out, to control or to implement the steps of a variant of a method presented here in suitable devices. This device may be designed as the inertial measurement unit in which individual units are provided which can perform the relevant steps. You through this embodiment variant of the approach in the form of a device, the underlying problem of the approach can be solved quickly and efficiently.

For this purpose, the device may have at least one computing unit for processing signals or data, at least one memory unit for storing signals or data, at least one interface to a sensor or an actuator for reading sensor signals from the sensor or for outputting data or control signals to the actuator and/or at least one communication interface for reading or outputting data embedded in a communication protocol. For example, the computing unit may be a signal processor, a microcontroller, or the like, wherein the memory unit may be a flash memory, an EEPROM or a magnetic memory unit. The communication interface may be designed to read or output data wirelessly and/or wired, wherein a communication interface that can read or output wired data can read this data electrically or optically from a corresponding data transmission line or output it into a corresponding data transmission line, for example.

In the present case, a device can be understood as an electrical unit that processes sensor signals and, depending thereon, outputs control signals and/or data signals. The device may have an interface that can be of hardware and/or software form. In a hardware form, the interfaces can be, for example, part of a so-called system ASIC, which contains various functions of the device. However, it is also possible that the interfaces are dedicated integrated circuits or at least partially discrete components. In the case of a software form, the interfaces are software modules, which are available, for example, on a microcontroller along with other software modules.

A computer program product or a computer program is advantageous that has a program code that may be stored on a machine-readable carrier or storage medium such as a semiconductor memory, a hard disk memory or an optical memory, and which is used to perform, implement and/or control the steps of the method according to any one of the embodiments described above, in particular when the program product or program is executed on a computer or a device.

### BRIEF DESCRIPTION OF THE DRAWINGS

Exemplary embodiments of the approach presented here are shown in the drawings and explained in more detail in the following description. In the figures:

FIG. 1 shows an exemplary scenario for producing a calibration value for calibrating an inertial measurement unit of a vehicle

FIG. 2 shows an illustration in which the misalignments of the measurement axes of the measuring sensor relative to the reference measurement directions of the reference coordinate system are shown;

FIG. 3 shows a flow diagram of an embodiment of a method for producing a calibration value for calibrating an inertial measurement unit for a vehicle; and

FIG. 4 shows a flow diagram of an embodiment of a method for compensating a measurement value of a measuring sensor of an inertial measurement unit.

### DETAILED DESCRIPTION

In the following description of favorable exemplary embodiments of the present approach, identical or similar matching reference characters are used for the similarly acting elements represented by the different figures, wherein a repeated description of these elements is omitted.

FIG. 1 shows an example scenario for producing a calibrating value (also referred to as a calibration value) for calibrating an inertial measurement unit 100 for a vehicle 105. Here, the inertial measurement unit 100 may be provided to produce measurement values, which however need not yet be very precise high accuracy values, for example, and which can then still be used for functions of autonomous driving. In order to provide these measurement values, a measuring sensor 110 is provided, which can detect measurement values of a physical variable in different measurement directions, here an acceleration for example, and can output corresponding signals. For example, the measuring sensor 110 can output a first measurement value 115, which represents a component of the physical variable in a first measurement direction 120, here for example in an x-direction. Similarly, the measuring sensor 110 can output a second measurement value 125, which represents a component of the physical variable in a second measurement direction 130, here for example in a y-direction, and wherein the measuring sensor 110 can also output a third measurement value 135, which represents a component of the physical variable in a third measurement direction 140, here for example in a z-direction. The corresponding measurement values 115, 125 and 135 can be fed via an interface 142 to a detection unit 145, in which a first correction angle value 146, a second correction angle value 147 and advantageously also a third correction angle value 148 are determined, which are then fed to a memory unit 149.

For the use of the inertial measurement unit 110 it is now important that due to production-related factors, taking into account reasonable costs for the mass production, the measuring sensor 110 can usually not be produced with high quality, so that the measurement values 115, 125 and 135 are often not measured in the precise directions that correspond to the axes of a Cartesian (reference) coordinate system R, as reproduced in FIG. 1 by the x-axis 150, the y-axis 155 and the z-axis 160. In order to achieve a correction or compensation of the measuring devices 115, 125 and 135, a reference sensor 165 is now used, for example in a laboratory environment, which has very high precision in the measurement of a physical variable such as acceleration with respect to the detection of components in the real x-axis 150, the real y-axis 155 and/or the real z-axis 160. The use of the reference sensor 165 therefore allows the provision of a first reference value 170, which corresponds to a component of the physical variable in the first reference direction 150, i.e. here the x-axis of the reference coordinate system R. In addition, the use of the reference sensor 165 enables the provision of a second reference value 172 corresponding to a component of the physical variable in the second reference direction 155, i.e. the y-axis of the reference coordinate system R, and the provision of a third reference value 173, which corresponds to a component of the physical variable in the third reference direction 160, here the z-axis of the reference coordinate system R.

In the determination unit 145 (in addition to the first measurement value 115, the second measurement value 125 and the third measurement value 135) the first reference value 170, the second reference value 172 and/or the third reference value 173 can be read in. Using the first measurement value 115 and the first reference value 170, the first correction angle value 146 can then be determined, wherein this correction angle value 146 then indicates by which parameter and in which direction the first measurement value is to be transformed into the first reference measurement direction 150 of the reference coordinate system R (and if necessary additionally by which parameter and in which direction the first measurement value 115 is to be transformed into the second reference measurement direction 155 of the reference coordinate system R and/or by which parameter and in which direction the first measurement value 115 is to be transformed into the third reference measurement direction 160) in order to correspond to a value in the first reference measurement direction 150 of the reference coordinate system R. Analogously, in the determination unit 145, using the second measurement value 125 and the second reference value 172 the second correction angle value 147 can be determined, wherein this correction angle value 147 then indicates by which parameter and in which direction the second measurement value 125 is to be transformed into the second reference measurement direction 155 of the reference coordinate system R (and optionally additionally by which parameter and in which direction the second measurement value 125 is to be transformed into the first reference measurement direction 150 of the reference coordinate system R and/or by which parameter and in which direction the second measurement value 125 is to be transformed into the third reference measurement direction 160) in order to correspond to a value in the second reference measurement direction 155 of the reference coordinate system R. Also, in the determination unit 145, using the third measurement value 135 and the third reference value 173 the third correction angle value 148 can be determined, wherein this correction angle value 148 then indicates by which parameter and in which direction the third measurement value 135 is to be transformed into the third reference measurement direction 160 of the reference coordinate system R (and if necessary additionally by which parameter and in which direction the third measurement value 135 is to be transformed into the first reference measurement direction 150 of the reference coordinate system R and/or by which parameter and in which direction the third measurement value 135 is to be transformed into the third reference measurement direction 160) in order to correspond to a value in the third reference measurement direction 155 of the reference coordinate system R. The first correction angle value 146, the second correction angle value 147 and/or the third correction angle value 148 can then be denoted as a calibration value 175 or also a calibrating value, stored in the memory unit 140 and retained for the operation of the unit 100 while the vehicle 105 is travelling.

It is also conceivable that the determination unit 145 is not provided as a processor in the inertial measurement unit 100, but is arranged outside the inertial measurement unit 100 and the correction angle values 146, 147 and/or 148 are externally determined and stored in the memory unit 149 as a calibration value 175. It is also conceivable that the determination unit 145 is designed to determine the correction angle value the for implementation when using artificial intelligence techniques such as a neural network.

When operating the vehicle in a real scenario, i.e. outside the laboratory environment in which the reference sensor 165 is available, a corrected or compensated measurement value 180 can then be output, for example for a driver's assistance function for autonomous driving, which represents a very precise physical variable in a direction or axis of the reference coordinate system R. For this purpose, for example, the first measurement value 115 of the measuring sensor 110, the second measurement value 125 and/or the third measurement value 135 are linked with the respective corresponding correction angle value 146, 147 and/or 148 from the calibration value 175 read out from the memory unit 149, so that the corrected or compensated measurement value 180 can be determined in a processor hosting the determination unit 145. In this way, cost-effective means such as a conventional measuring sensor 110 can still be used to measure the physical variable, which meets high quality requirements, such as those required for the functions of autonomous driving of the vehicle 105, for example.

FIG. 2 shows an illustration showing the misalignment of the measurement axes 120 (Gₓ), 130 (G_{y}) and 140 (G_{z}) of the measuring sensor 110 relative to the reference measurement directions 150 (X), 155 (Y) and 160 (Z) of the reference coordinate system R. It can also be seen that the first correction angle value 146 (Ψₓ) specifies a parameter by which the first measurement value 115 recorded in the first measurement direction 120 is to be transformed in order to correspond to a measurement value in the first reference direction 150. Here it can also be seen that the first correction angle value 146 has a first component θ_{XY} in the second reference measurement direction 155 and a second component φ_{XZ} in the third reference measurement direction 160. Analogously it can also be seen that the second correction angle value 147 (Ψ_{Y}) specifies a parameter by which the second measurement value 125 detected in the second measurement direction 130 is to be transformed in order to correspond to a measurement value in the second reference direction 155, wherein the second correction angle value 147 has a first component θ_{YX} in the first reference measurement direction 150 and a second component θ_{YZ} in the third reference measurement direction 160. Finally, it can also be seen that the third correction angle value 148 (Ψ_{Z}) specifies a parameter by which the third measurement value 135 detected in the third measurement direction 140 is to be transformed in order to correspond to a measurement value in the third reference direction 160, wherein the third correction angle value 148 has a first component φ_{ZY} in the first reference measurement direction 150 and a second component φ_{ZY} in the second reference measurement direction 155. From this it can be seen that there is an easy way to perform the transformation due to the different components of the correction angle values 146, 147 and 148.

Details of the approach presented here are described again in more detail below in accordance with exemplary embodiments. Especially by artificial intelligence, system calibration methods for the compensation of misalignments (offset compensation) for inertial measurement units of a microelectromechanical system, in short “MEMS-IMU-Sensors” (Micro-Electro-Mechanical System-Inertial Measurement Unit) can be supported. The system calibration software supported by artificial intelligence could, according to one exemplary embodiment, be used with a modified calibration process during the manufacture or calibration of the inertial measurement unit, which could increase the speed of the calibration time and thus shorten the production time. The more measurement data are available, the better or more meaningful it can be to omit an evaluation.

Furthermore, it can be implemented that according to one exemplary embodiment the offset compensation aims to reduce the deviation of the sensor axes of the measuring sensor 110 from an orthogonal coordinate system such as the reference coordinate system R. The method according to an exemplary embodiment presented here could use a complex rotation pattern (instead of a very simple direction by individual directional rotations) in the calibration chamber, which could shorten the calibration time. Thus, proportions are calculated jointly as a whole, i.e. in more than one spatial direction, which means that the complexity of such a calculation is increased; however, the speed of calibration can be increased and thereby individual measuring units can be measured individually in a very short manufacturing time and yet a precise measuring system can be provided.

In addition, according to one exemplary embodiment the artificial intelligence could find new unknown features or functions based on the data which could predict the behavior or calculate the probability of when or whether sensors are unusable or defective.

FIG. 3 shows a flow diagram of an exemplary embodiment of a method 300 for producing a calibration value for calibrating an inertial measurement unit for a vehicle. The method 300 includes a step 310 of reading a first measurement value of a physical variable in a first measurement direction of a measuring sensor of an inertial measurement unit and a second measurement value of the physical variable in a second measurement direction deviating from the first measurement direction of the measuring sensor of the inertial measurement unit and reading a first reference value of the physical variable in a first reference measurement direction of a reference sensor and a second reference value of the physical variable in a second reference measurement direction deviating from the first reference measurement direction of the reference sensor. Furthermore, the method 300 includes a step 320 of determining a first correction angle value using the first measurement value and the first reference value and determining a second correction angle value using the second measurement and the second reference value. Finally, the method 300 includes a step 330 of storing the first and second correction angle values in a memory of the inertial measurement unit in order to obtain the calibration value.

FIG. 4 shows a flow diagram of an exemplary embodiment of a method for compensation of a measurement value of a measuring sensor of an inertial measurement unit 100. The method 400 includes a step 410 of reading at least the measurement value of the measuring sensor of the inertial measurement unit and a calibration value stored in a memory unit of the inertial measurement unit according to a variant of a method presented here. Furthermore, the method 400 includes a step 420 of determining a compensated measurement value using the measurement value and the calibration value.

This may be a method which can be carried out by one of the devices described on the basis of the preceding figures or the inertial measurement unit 100.

The steps of the method presented here may be repeated and performed in a different order than in the order described.

Where an exemplary embodiment includes an “and/or” link between a first feature and a second feature, this shall be read in such a way that the exemplary embodiment according to an implementation has both the first feature and the second feature and, according to a further implementation, either only the first feature or the second feature.

What is claimed is:

1. A method for producing a calibration value for calibrating an inertial measurement unit for a vehicle, comprising:
reading a first measurement value of a physical variable in a first measurement direction of a measuring sensor of the inertial measurement unit;
reading a second measurement value of the physical variable in a second measurement direction of the measuring sensor of the inertial measurement unit which differs from the first measurement direction;
reading a first reference value of the physical variable in a first reference measurement direction of a reference sensor;
reading a second reference value of the physical variable in a second reference measurement direction of the reference sensor which differs from the first reference measurement direction;
determining a first correction angle value using the first measurement value and the first reference value;
determining a second correction angle value using the second measurement value and the second reference value; and
storing the first correction angle value and the second correction angle value in a memory of the inertial measurement unit to obtain the calibration value.

2. The method according to claim 1, wherein:
the first correction angle value represents a first angular offset between the first measurement direction and the first reference measurement direction, and
the second correction angle value represents a second angular offset between the second measurement direction and the second reference measurement direction.

3. The method according to claim 1, further comprising:
reading a third measurement value of the physical variable in a third measurement direction different from the first measurement direction and the second measurement direction of the measuring sensor of the inertial measurement unit;
reading a third reference value of the physical variable in a third reference measurement direction of the reference sensor different from the first reference measurement direction and the second reference measurement direction of the reference sensor;
determining a third correction angle value with the third measurement value and the third reference value; and
storing the third correction angle value in the memory of the inertial measurement unit in order to obtain the calibration value.

4. The method according to claim 3, wherein:
the first correction angle has a component of the second reference measurement direction and/or the third reference measurement direction, and
the second correction value has a component of the first reference measurement direction and/or the third reference measurement direction.

5. The method according to claim 1, further comprising:
determining the first correction angle value and the second correction angle value using an artificial intelligence algorithm and/or an artificial neural network.

6. The method according to claim 1, further comprising:
reading the first reference measurement value and/or the second reference measurement value (i) with a measuring unit when the reference sensor which is stationary or is moving, or (ii) in a laboratory environment.

7. The method according to claim 1, wherein:
the first measurement value, the second measurement value, the first reference measurement value, and the second reference measurement value are each read as a corresponding value representing an acceleration, and
the acceleration is the physical variable.

8. The method according to claim 1, further comprising:
jointly determining the first correction angle value and the second correction angle value in an algorithm; and
using the first measurement value, the first reference value, the second measurement value, and the second reference value to determine the first correction angle value and the second correction angle value.

9. The method according to claim 1, wherein a device is configured to perform and/or to control the method.

10. The method according to claim 1, wherein a computer program is configured to perform and/or to control the method.

11. The method according to claim 10, wherein the computer program is stored on a machine-readable memory medium.

12. A method for compensating a measurement value of a measuring sensor of an inertial measurement unit, comprising:
reading at least the measurement value from the measuring sensor of the inertial measurement unit;
reading a calibration value stored in a memory unit of the inertial measurement unit; and
determining a compensated measurement value using the measurement value and the calibration value,
wherein the calibration value is determined by:
reading a first measurement value of a physical variable in a first measurement direction of the measuring sensor of the inertial measurement unit;
reading a second measurement value of the physical variable in a second measurement direction of the measuring sensor of the inertial measurement unit which differs from the first measurement direction;
reading a first reference value of the physical variable in a first reference measurement direction of a reference sensor;
reading a second reference value of the physical variable in a second reference measurement direction of the reference sensor which differs from the first reference measurement direction;
determining a first correction angle value using the first measurement value and the first reference value;
determining a second correction angle value using the second measurement value and the second reference value; and
storing the first correction angle value and the second correction angle value in the memory unit of the inertial measurement unit to determine the calibration value.
